(19) United States
(12) Patent Application Publication
(10) Pub. No.: US 2025/0113312 A1
(43) Pub. Date: Apr. 3, 2025

(54) APPARATUS, METHOD AND COMPUTER PROGRAM

(71) Applicant: Nokia Technologies Oy, Espoo (FI)

(72) Inventors: Satya Krishna JOSHI, Oulu (FI); Dileep KUMAR, Espoo (FI); Aki HEKKALA, Oulu (FI); Hyun-Su CHA, Naperville, IL (US)

(21) Appl. No.: 18/897,072

(22) Filed: Sep. 26, 2024

(30) Foreign Application Priority Data
Sep. 29, 2023 (GB) 2315043.6

(51) Int. Cl. H04W 56/00

(52) U.S. Cl. CPC H04W 56/001; H04W 56/005

(57) ABSTRACT

An apparatus including means for performing at least one reference signal carrier phase, RSCP, measurement for a signal, means for determining a coherence time, wherein coherence time is a time duration that an initial phase of the signal does not change beyond a threshold, means for determining, based on the determined coherence time, to provide at least one of the following to the network function: the at least one RSCP measurement or an indication of the determined coherence time and means for providing to a network function the determined at least one of the following: the at least one RSCP measurement or an indication of the determined coherence time.

### FIELD

The present application relates to a method, apparatus, system and computer program and in particular but not exclusively to the bi-directional carrier phase measurement considering coherence time of initial phase offsets.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is Universal Mobile Telecommunications System (UMTS) Terrestrial Radio Access Network (UTRAN) (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP). Other examples of communication systems include 5G-Advanced (NR Rel-18 and beyond) and 6G.

### SUMMARY

In a first aspect there is provided an apparatus comprising means for means for performing at least one reference signal carrier phase, RSCP, measurement for a signal, means for determining a coherence time, wherein coherence time is a time duration that an initial phase of the signal does not change beyond a threshold, means for determining, based on the determined coherence time, to provide at least one of the following to the network function: the at least one RSCP measurement or an indication of the determined coherence time and means for providing to a network function the determined at least one of the following: the at least one RSCP measurement or an indication of the determined coherence time.

The apparatus may comprise means for receiving, from the network function, a coherence time determined at the network function at least for one transmission and reception point, TRP.

The apparatus may comprise means for receiving, from the network function, a request to perform M RSCP measurements based on the provided coherence time at least for one TRP and the determined coherence time of the apparatus, where M is an integer greater than or equal to 1.

The apparatus may comprise means for determining a required time period to perform M DL RSCP measurements with respect to a TRP based on a provided configuration on downlink positioning reference signals, DL PRS or to perform M UL RSCP measurements with respect to a UE based on uplink sounding reference signals, UL SRS and means for providing the determined time period to the network function.

The apparatus may comprise means for determining whether the apparatus can perform the M RSCP measurements within the provided coherence time or the determined coherence time.

The apparatus may comprise means for transmitting a request for reconfiguration of at least one of the UL SRS or DL PRS to perform the M RSCP measurements within the provided coherence time or the determined coherence time.

Determining to provide at least one of the following: the at least one RSCP measurement or the determined coherence time to the network function may be further based on the determined time period.

If the determined coherence time is greater than the determined time period, the apparatus may comprise means for providing the at least one RSCP measurement to the network function and if the determined coherence time is less than the determined time period, means for providing an indication of the determined coherence time to the network function.

The apparatus may comprise means for receiving a request from the network function to provide the determined coherence time.

The network function may comprise a location management function. The apparatus may comprises a transmit receive point and the RSCP measurements may be based on an uplink sounding reference signal. The apparatus may comprise a user equipment and the RSCP measurements may be based on a downlink positioning reference signal transmission.

In a second aspect there is provided an apparatus comprising means for receiving by a network function, from a user equipment or a transmit receive point, at least one of the following: at least one reference signal carrier phase measurement or an indication of a determined coherence time.

The apparatus may comprise means for providing, from the network function, a coherence time determined at the network function for at least for one transmission and reception point, TRP.

The apparatus may comprise means for providing, from the network function, a request to perform M RSCP measurements based on the provided coherence time at least for one TRP and a determined coherence time of the apparatus, where M is an integer greater than or equal to 1.

The apparatus may comprise means for providing a configuration on downlink positioning reference signals, DL PRS, and means for receiving a determined required time period to perform M RSCP measurements with respect to a TRP based on the received configuration or means for providing a configuration on uplink sounding reference signals, UL SRS, and means for receiving a determined required time period to perform M RSCP measurements with respect to a UE based on the provided configuration.

The apparatus may comprise means for providing a request from the network function to the transmit receive point or the user equipment to provide the determined coherence time.

The apparatus may comprise means for determining, based on the received coherence time, if a transmit receive point or user equipment is suitable for performing a positioning procedure.

The apparatus may comprise means for determining there are insufficient user equipment or transmit receive points for performing the positioning procedure and means for providing a reconfiguration of reference signal resources to the user equipment or the transmit receive point.

In a third aspect there is provided a method comprising performing at least one reference signal carrier phase, RSCP, measurement for a signal, determining a coherence time, wherein coherence time is a time duration that an initial phase of the signal does not change beyond a threshold, determining, based on the determined coherence time, to provide at least one of the following to the network function: the at least one RSCP measurement or an indication of the determined coherence time and providing to a network function the determined at least one of the following: the at least one RSCP measurement or an indication of the determined coherence time.

The method may comprise receiving, from the network function, a coherence time determined at the network function at least for one transmission and reception point, TRP.

The method may comprise receiving, from the network function, a request to perform M RSCP measurements based on the provided coherence time at least for one TRP and the determined coherence time of the apparatus, where M is an integer greater than or equal to 1.

The method may comprise determining a required time period to perform M DL RSCP measurements with respect to a TRP based on a provided configuration on downlink positioning reference signals, DL PRS or to perform M UL RSCP measurements with respect to a UE based on uplink sounding reference signals, UL SRS and providing the determined time period to the network function.

The method may comprise determining whether the apparatus can perform the M RSCP measurements within the provided coherence time or the determined coherence time.

The method may comprise transmitting a request for reconfiguration of at least one of the UL SRS or DL PRS to perform the M RSCP measurements within the provided coherence time or the determined coherence time.

Determining to provide at least one of the following: the at least one RSCP measurement or the determined coherence time to the network function may be further based on the determined time period.

If the determined coherence time is greater than the determined time period, the method may comprise providing the at least one RSCP measurement to the network function and if the determined coherence time is less than the determined time period, providing an indication of the determined coherence time to the network function.

The method may comprise receiving a request from the network function to provide the determined coherence time.

The network function may comprise a location management function. The method may be performed at a transmit receive point and the RSCP measurements may be based on an uplink sounding reference signal. The method may be performed at a user equipment and the RSCP measurements may be based on a downlink positioning reference signal transmission.

In a fourth aspect there is provided a method comprising receiving by a network function, from a user equipment or a transmit receive point, at least one of the following: at least one reference signal carrier phase measurement or an indication of a determined coherence time.

The method may comprise providing, from the network function, a coherence time determined at the network function for at least for one transmission and reception point, TRP.

The method may comprise providing, from the network function, a request to perform M RSCP measurements based on the provided coherence time at least for one TRP and a determined coherence time of the apparatus, where M is an integer greater than or equal to 1.

The method may comprise providing a configuration on downlink positioning reference signals, DL PRS, and receiving a determined required time period to perform M RSCP measurements with respect to a TRP based on the received configuration or providing a configuration on uplink sounding reference signals, UL SRS, and receiving a determined required time period to perform M RSCP measurements with respect to a UE based on the provided configuration.

The method may comprise providing a request from the network function to the transmit receive point or the user equipment to provide the determined coherence time.

The method may comprise determining, based on the received coherence time, if a transmit receive point or user equipment is suitable for performing a positioning procedure.

The method may comprise determining there are insufficient user equipment or transmit receive points for performing the positioning procedure and providing a reconfiguration of reference signal resources to the user equipment or the transmit receive point.

In a fifth aspect there is provided an apparatus comprising at least one processor, and at least one memory storing instructions which, when executed by the processor, cause the apparatus at least to perform at least one reference signal carrier phase, RSCP, measurement for a signal, determine a coherence time, wherein coherence time is a time duration that an initial phase of the signal does not change beyond a threshold, determine, based on the determined coherence time, to provide at least one of the following to the network function: the at least one RSCP measurement or an indication of the determined coherence time and provide to a network function the determined at least one of the following: the at least one RSCP measurement or an indication of the determined coherence time.

The apparatus may be caused to receive, from the network function, a coherence time determined at the network function at least for one transmission and reception point, TRP.

The apparatus may be caused to receive, from the network function, a request to perform M RSCP measurements based on the provided coherence time at least for one TRP and the determined coherence time of the apparatus, where M is an integer greater than or equal to 1.

The apparatus may be caused to determine a required time period to perform M DL RSCP measurements with respect to a TRP based on a provided configuration on downlink positioning reference signals, DL PRS or to perform M UL RSCP measurements with respect to a UE based on uplink sounding reference signals, UL SRS and provide the determined time period to the network function.

The apparatus may be caused to determine whether the apparatus can perform the M RSCP measurements within the provided coherence time or the determined coherence time.

The apparatus may be caused to transmit a request for reconfiguration of at least one of the UL SRS or DL PRS to perform the M RSCP measurements within the provided coherence time or the determined coherence time.

Determining to provide at least one of the following: the at least one RSCP measurement or the determined coherence time to the network function may be further based on the determined time period.

If the determined coherence time is greater than the determined time period, the apparatus may be caused to provide the at least one RSCP measurement to the network function and if the determined coherence time is less than the determined time period, provide an indication of the determined coherence time to the network function.

The apparatus may be caused to receive a request from the network function to provide the determined coherence time.

The network function may comprise a location management function. The apparatus may comprise a transmit receive point and the RSCP measurements may be based on an uplink sounding reference signal. The apparatus may comprise a user equipment and the RSCP measurements may be based on a downlink positioning reference signal transmission.

In a sixth aspect there is provided an apparatus comprising at least one processor, and at least one memory storing instructions which, when executed by the processor, cause the apparatus at least to receive by a network function, from a user equipment or a transmit receive point, at least one of the following: at least one reference signal carrier phase measurement or an indication of a determined coherence time.

The apparatus may be caused to provide, from the network function, a coherence time determined at the network function for at least for one transmission and reception point, TRP.

The apparatus may be caused to provide, from the network function, a request to perform M RSCP measurements based on the provided coherence time at least for one TRP and a determined coherence time of the apparatus, where M is an integer greater than or equal to 1.

The apparatus may be caused to provide a configuration on downlink positioning reference signals, DL PRS, and receive a determined required time period to perform M RSCP measurements with respect to a TRP based on the received configuration or provide a configuration on uplink sounding reference signals, UL SRS, and receive a determined required time period to perform M RSCP measurements with respect to a UE based on the provided configuration.

The apparatus may be caused to provide a request from the network function to the transmit receive point or the user equipment to provide the determined coherence time.

The apparatus may be caused to determine, based on the received coherence time, if a transmit receive point or user equipment is suitable for performing a positioning procedure.

The apparatus may be caused to determine there are insufficient user equipment or transmit receive points for performing the positioning procedure and provide a reconfiguration of reference signal resources to the user equipment or the transmit receive point.

In a seventh aspect there is provided a computer readable medium comprising instructions which, when executed by an apparatus, cause the apparatus to perform at least the following: performing at least one reference signal carrier phase, RSCP, measurement for a signal, determining a coherence time, wherein coherence time is a time duration that an initial phase of the signal does not change beyond a threshold, determining, based on the determined coherence time, to provide at least one of the following to the network function: the at least one RSCP measurement or an indication of the determined coherence time and providing to a network function the determined at least one of the following: the at least one RSCP measurement or an indication of the determined coherence time.

The apparatus may be caused to perform receiving, from the network function, a coherence time determined at the network function at least for one transmission and reception point, TRP.

The apparatus may be caused to perform receiving, from the network function, a request to perform M RSCP measurements based on the provided coherence time at least for one TRP and the determined coherence time of the apparatus, where M is an integer greater than or equal to 1.

The apparatus may be caused to perform determining a required time period to perform M DL RSCP measurements with respect to a TRP based on a provided configuration on downlink positioning reference signals, DL PRS or to perform M UL RSCP measurements with respect to a UE based on uplink sounding reference signals, UL SRS and providing the determined time period to the network function.

The apparatus may be caused to perform determining whether the apparatus can perform the M RSCP measurements within the provided coherence time or the determined coherence time.

The apparatus may be caused to perform transmitting a request for reconfiguration of at least one of the UL SRS or DL PRS to perform the M RSCP measurements within the provided coherence time or the determined coherence time.

Determining to provide at least one of the following: the at least one RSCP measurement or the determined coherence time to the network function may be further based on the determined time period.

If the determined coherence time is greater than the determined time period, the apparatus may be caused to perform providing the at least one RSCP measurement to the network function and if the determined coherence time is less than the determined time period, the apparatus may be caused to perform providing an indication of the determined coherence time to the network function.

The apparatus may be caused to perform receiving a request from the network function to provide the determined coherence time.

The network function may comprise a location management function. The apparatus may comprises a transmit receive point and the RSCP measurements may be based on an uplink sounding reference signal. The apparatus may comprise a user equipment and the RSCP measurements may be based on a downlink positioning reference signal transmission.

In an eighth aspect there is provided a computer readable medium comprising instructions which, when executed by an apparatus, cause the apparatus to perform at least the following: receiving by a network function, from a user equipment or a transmit receive point, at least one of the following: at least one reference signal carrier phase measurement or an indication of a determined coherence time.

The apparatus may be caused to perform providing, from the network function, a coherence time determined at the network function for at least for one transmission and reception point, TRP.

The apparatus may be caused to perform providing, from the network function, a request to perform M RSCP measurements based on the provided coherence time at least for one TRP and a determined coherence time of the apparatus, where M is an integer greater than or equal to 1.

The apparatus may be caused to perform providing a configuration on downlink positioning reference signals, DL PRS, and receiving a determined required time period to perform M RSCP measurements with respect to a TRP based on the received configuration or means for providing a configuration on uplink sounding reference signals, UL SRS, and receiving a determined required time period to perform M RSCP measurements with respect to a UE based on the provided configuration.

The apparatus may be caused to perform providing a request from the network function to the transmit receive point or the user equipment to provide the determined coherence time.

The apparatus may be caused to perform determining, based on the received coherence time, if a transmit receive point or user equipment is suitable for performing a positioning procedure.

The apparatus may be caused to perform determining there are insufficient user equipment or transmit receive points for performing the positioning procedure and providing a reconfiguration of reference signal resources to the user equipment or the transmit receive point.

In a ninth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a signalling flow of bi-directional (RTT) carrier phase measurements;

FIG. 5 shows a signalling diagram for RTT carrier phase measurements against time;

FIG. 6 shows a flowchart of a method according to an example embodiment;

FIG. 7 shows a flowchart of a method according to an example embodiment;

FIG. 8 shows a signalling diagram according to an example embodiment;

FIG. 9 shows a signalling diagram according to an example embodiment.

### DETAILED DESCRIPTION

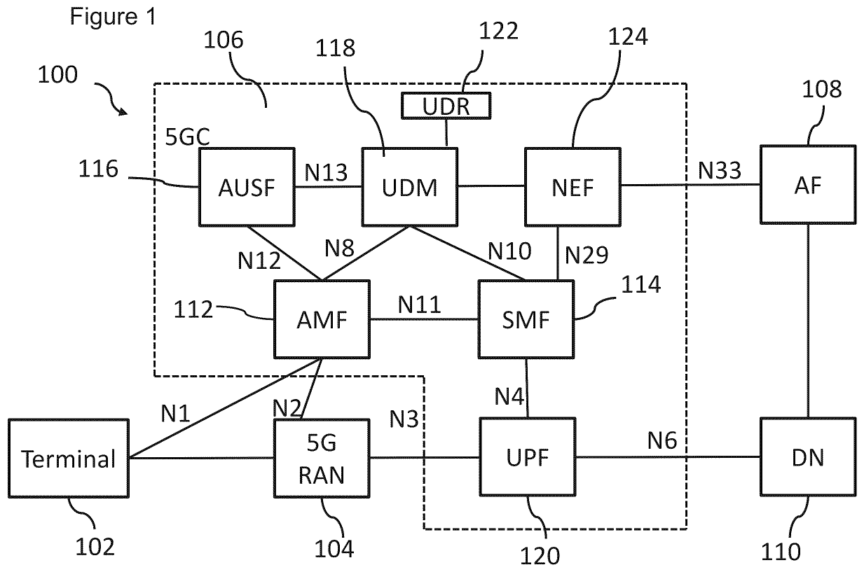

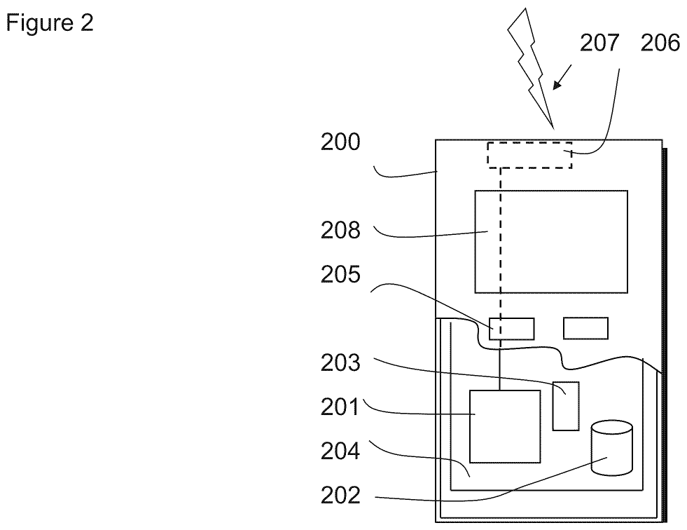

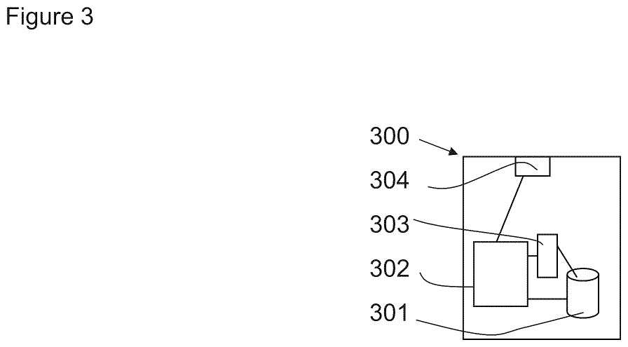

Before explaining in detail the examples, certain general principles of a wireless communication system and mobile communication devices are briefly explained with reference to FIG. 1, FIG. 2 and FIG. 3 to assist in understanding the technology underlying the described examples.

An example of a suitable communications system is the 5G or NR concept. Network architecture in NR may be similar to that of LTE-advanced. Base stations of NR systems may be known as next generation NodeBs (gNBs). Changes to the network architecture may depend on the need to support various radio technologies and finer Quality of Service (QOS) support, and some on-demand requirements for e.g. QoS levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use Multiple Input-Multiple Output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more internal or external application functions (AF) 108 and one or more data networks (DN) 110.

An example 5G core network (CN) comprises functional entities. The 5GCN 106 may comprise one or more Access and mobility Management Functions (AMF) 112, one or more session management functions (SMF) 114, an authentication server function (AUSF) 116, a Unified Data Management (UDM) 118, one or more user plane functions (UPF) 120, a Unified Data Repository (UDR) 122 and/or a Network Exposure Function (NEF) 124. The UPF is controlled by the SMF (Session Management Function) that receives policies from a PCF (Policy Control Function).

The CN is connected to a UE via the Radio Access Network (RAN). The 5GRAN may comprise one or more gNodeB (gNB) Distributed Unit (DU) functions connected to one or more gNodeB (gNB) Centralized Unit (CU) functions. The RAN may comprise one or more access nodes.

A User Plane Function (UPF) referred to as PDU Session Anchor (PSA) may be responsible for forwarding frames back and forth between the DN and the tunnels established over the 5G towards the UE(s) exchanging traffic with the DN.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VoIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts, and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant components can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

FIG. 3 shows an example of a control apparatus 300 for a communication system, for example to be coupled to and/or for controlling a station of an access system, such as a RAN node, e.g. a base station, eNB or gNB, a relay node or a core network node such as an MME or Serving Gateway (S-GW) or Packet Data Network Gateway (P-GW), or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

The following may be applicable to the positioning of Reduced Capability (RedCap) devices. RedCap bandwidth is limited to 20 MHz at maximum. In positioning techniques, small bandwidth leads to low accuracy. To solve this problem, a frequency hopping (FH) technique was developed for positioning. Mobility has not been considered for RedCap positioning. However, positioning should not be limited to stationary RedCap UE only. In FH case the movement may vary from hop to hop and cause problems in determining the position of the UE.

A Rel-18 work item has been agreed for further enhancement of 3GPP RAN1 NR positioning. One of the main topics is to support carrier phase (CP) positioning on top of the currently supported positioning technique.

The WID of CP positioning has been defined as specifying physical layer measurements and signaling to support NR DL and UL carrier phase positioning for UE-based, UE-assisted, and NG-RAN node assisted positioning. Existing DL PRS and UL SRS for positioning may be used for NR carrier phase measurements. Measurements that are limited to a single carrier/PFL are to be specified as well as corresponding core requirements, and identifying and specifying the impact on the existing RAN4 specification, including RRM measurements without measurement gaps in connected and inactive mode (including PRS measurement period/reporting) and procedures.

The round-trip time (RTT) type of carrier phase positioning method has been discussed. The RTT carrier phase positioning method may also be called a bi-directional carrier phase method. The bi-directional carrier phase measurement in the following is a RSCP (Reference Signal Carrier Phase measurement), which is described in more details below.

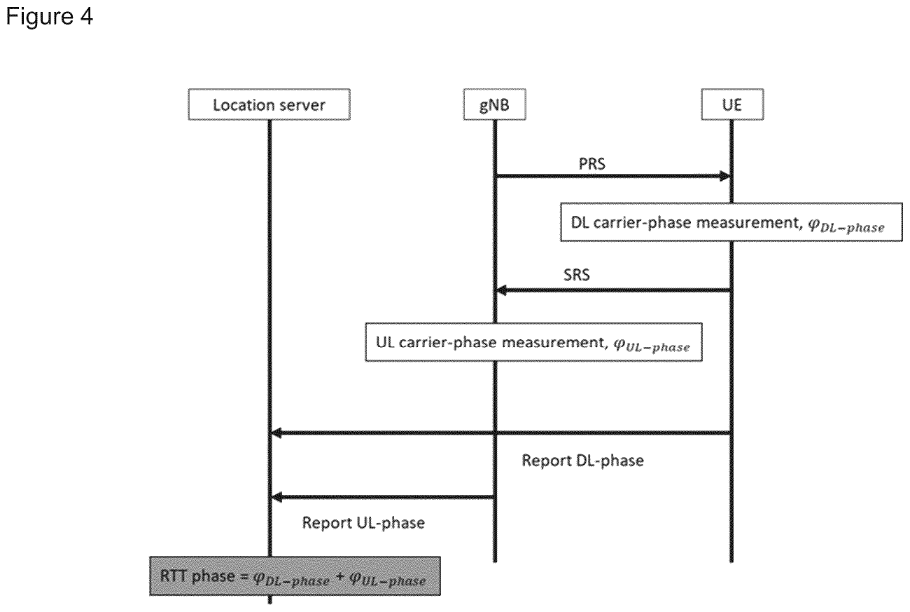

FIG. 4 shows a high level signalling diagram for bi-directional carrier phase measurements.

Using the DL carrier-phase measurement φ_{DL-phase}, the DL carrier-phase pseudo-range expression can be written as

$${φ}_{D L - p h a s e} + N = d / λ + ( {φ}_{U E 0 ( r x )} - {φ}_{g N B 0 ( t x )} ) \qquad ( 1 )$$

where N is the total number of full carrier cycles during DL carrier-phase measurements, d is the distance between gNB and UE during DL carrier-phase measurements, λ is carrier wavelength, φ_{UE0(rx)} is initial phase offset of UE as a receiver, and φ_{gNB0(tx)} is initial phase offset of gNB as a transmitter. The initial phase offsets φ_{UE0(rx)} and φ_{gNB0(tx)}, for example, could be caused by timing alignment errors, time offsets, frequency offsets, LO (Local Oscillator) initial phases, etc. Note that measured DL carrier-phase is a function of distance d and carrier wavelength λ, for static gNB and UE, and given by

$${φ}_{D L - p h a s e} = \frac{2 π d}{λ}$$

(mod 2π) radian. To ease the writing of expressions, we are expressing the measured phase φ_{DL-phase} (see equation (1)) in terms of ‘cycle’ (i.e., dividing the measurements by 2π).

Similarly, by using the UL carrier-phase measurement φ_{UL-phase}, the UL carrier-phase pseudo-range expression can be written as

$${φ}_{U L - p h a s e} + N = d / λ + ( {φ}_{g N B 0 ( r x )} - {φ}_{U E 0 ( t x )} ) \qquad ( 2 )$$

where φ_{gNB0(rx)} is initial phase offset of gNB as the receiver, and φ_{UE0(tx)} is initial phase offset of UE as a transmitter.

One channel parameter is the timescale by which effective-channel drifts. That is, the effective-channel drift as a function of time. The channel drift may be due to gNB and/or UE mobility or due to hardware specific issues for a static gNB and UE. This channel property can be quantified using the concept of coherence time.

Under an ideal coherence time condition, the initial phase offsets of gNB and UE both as transmitter/receiver are constant, i.e., are φ_{UE0(rx)}=φ_{UE0(tx)}, and φ_{gNB0(rx)}=φ_{gNB0(tx)}. In such case, the bi-directional (RTT) carrier phase (say (BD-phase) pseudo-range equation can be expressed as

$${φ}_{BD - phase} = {φ}_{DL - phase} + {φ}_{UL - phase} = 2 d / λ - 2 N \qquad ( 3 )$$

Note that in the above bi-directional phase observable expression (3), the unknown initial phase offsets of gNB and UE are canceled out. This property could make the use of bi-directional (RTT) carrier phase measurement a potential solution for high accuracy positioning.

NR DL reference signal carrier phase (RSCP) (of i-th path) is defined as the phase of the channel response at the i-th path delay derived from the resource elements (REs) that carry the DL PRS signals configured for the measurement. A RSCP is associated with a specific RF frequency.

The reference point of the RSCP, whether/how the measurement timing is defined is for further study.

The i-th path is used for the sake of definition, whether only the first path or additional paths will be supported is subject to further discussion.

The RSCP measurement indicates a carrier phase measurement between a TRP and a UE, which is not a differential measurement. In the above equations of this section, φ_{UL-phase} and φ_{DL-phase} represent a UL RSCP measurement and a DL RSCP measurement, respectively. Thus, the measurement reporting feature was supported, but is only a basic feature to support RTT type CP positioning.

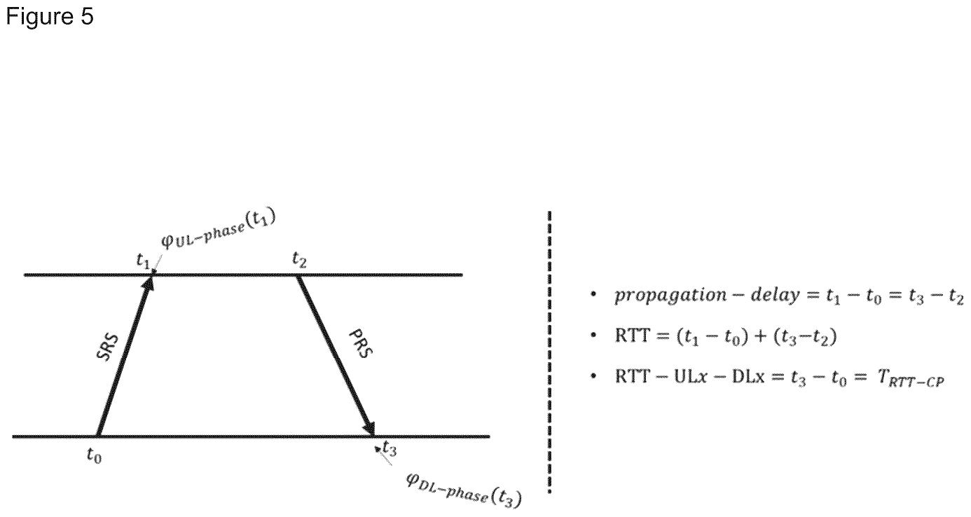

The potential benefit of the bi-directional carrier-phase based positioning in equation (3) is stated for the ideal measurement conditions. In practice, there is a time gap between the UL and DL carrier phase measurements, as illustrated in FIG. 5. A time-duration of concern for the carrier phase measurement procedure not only includes the RTT but additionally the time between DL and UL reference-signal transmissions, receptions, and corresponding radio measurement, that is a time-duration of T_{RTT-CP}=t₃−t₀ in Error! Reference source not found.5. We define T_{RTT-CP} as RTT-ULx-DLx (i.e., overall time duration over which RTT carrier phase measurement procedure takes place).

Over a duration of ΔT [time-units], the initial phase offsets (φ_{UE0(rx)}, φ_{UE0(tx)}) and (φ_{gNB0(rx)}, φ_{gNB0(tx)}) may fluctuate but the fluctuation would be limited within a certain time (depending, e.g., on the hardware-specific issues for a static gNB and UE), and thus the total cancelation of the initial phase offset cannot be achieved. The reason being that the phase offset will drift over time from the oscillator drift, etc. Thus, a long time difference between reception timing of DL PRS signal and transmission timing of UL SRS may be one of the factors of the phase drift.

However, in order to achieve high accuracy carrier-phase based positioning, we should not allow initial phase offsets during UL and DL measurements to change significantly (or kept within a tolerable level, i.e., abs(φ_{UE0(rx)}−φ_{UE0(tx)})≤ϵ and abs(φ_{gNB0(rx)}−φ_{gNB0(tx)})≤ϵ).

The following proposes a method to consider the coherence time induced by the initial phase-offset variations due to hardware impairments for bi-directional (also known as RTT) carrier phase measurement/positioning. The UE takes more decision steps and supports the network to take further action. The coherence time may be defined as the time duration of phase continuity that a TRP, such as a gNB, and/or a UE can keep or a time duration that the TRP and/or UE can keep the same phase value within a certain margin. Coherence time may depend on the gNB and/or UE capability and implementations. The coherence time at the UE may be different depending on antennas or antenna panels. Coherence time between a xth gNB and a UE may be denoted by T_{c}(gNBₓ). The initial phase is considered because coherence time is due to hardware impairments as opposed to mobility.

It should be noted that the coherence time in the following is not a channel coherence time, but means a time duration that a fluctuation or change of an initial phase at the UE or the TRP is kept less than a certain threshold value. For example, a 90 percent coherence time would mean the time duration that a fluctuation or change of an initial phase is kept less than 10 percent.

In the following, the UE is static and no contribution in the coherence-time is caused by UE mobility.

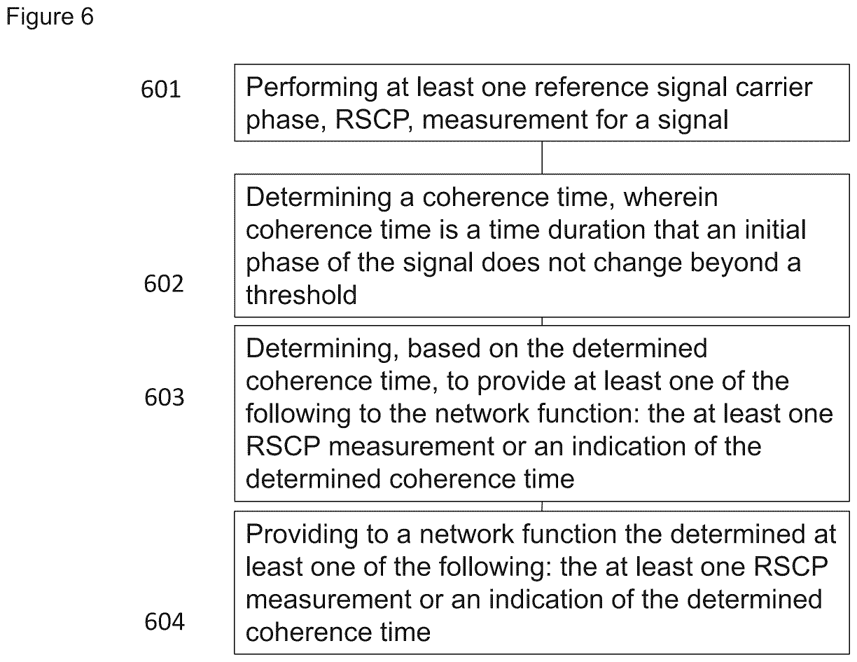

FIG. 6 shows a flowchart of a method according to an example embodiment. The method may be performed at a UE or a TRP.

In 601, the method comprises performing at least one reference signal carrier phase, RSCP, measurement for a signal.

In 602, the method comprises determining a coherence time, wherein coherence time is a time duration that an initial phase of the signal does not change beyond a threshold

In 603, the method comprises determining, based on the determined coherence time, to provide at least one of the following to the network function: the at least one RSCP measurement or an indication of the determined coherence time.

In 604, the method comprises providing to a network function the determined at least one of the following: the at least one RSCP measurement or an indication of the determined coherence time.

In an example embodiment, the method is performed at a user equipment and the RSCP measurements are based on a DL PRS.

In an example embodiment, the method is performed at a transmit receive point and the RSCP measurements are based on an UL SRS.

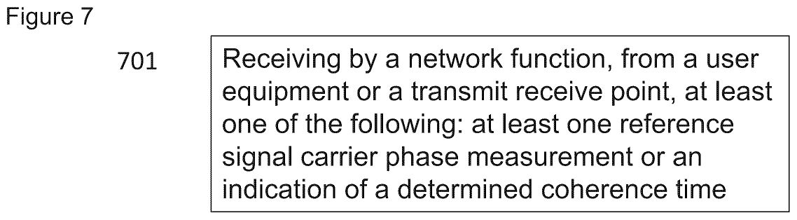

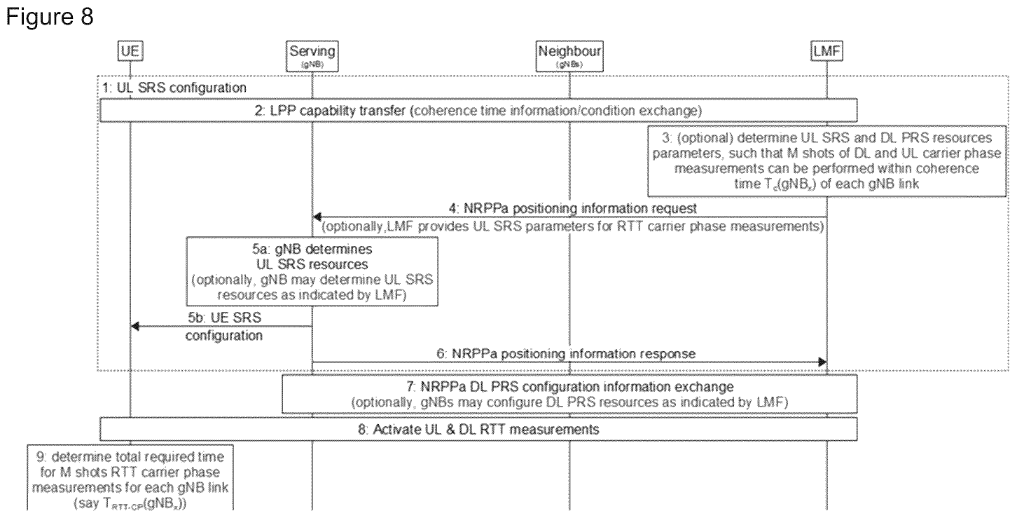

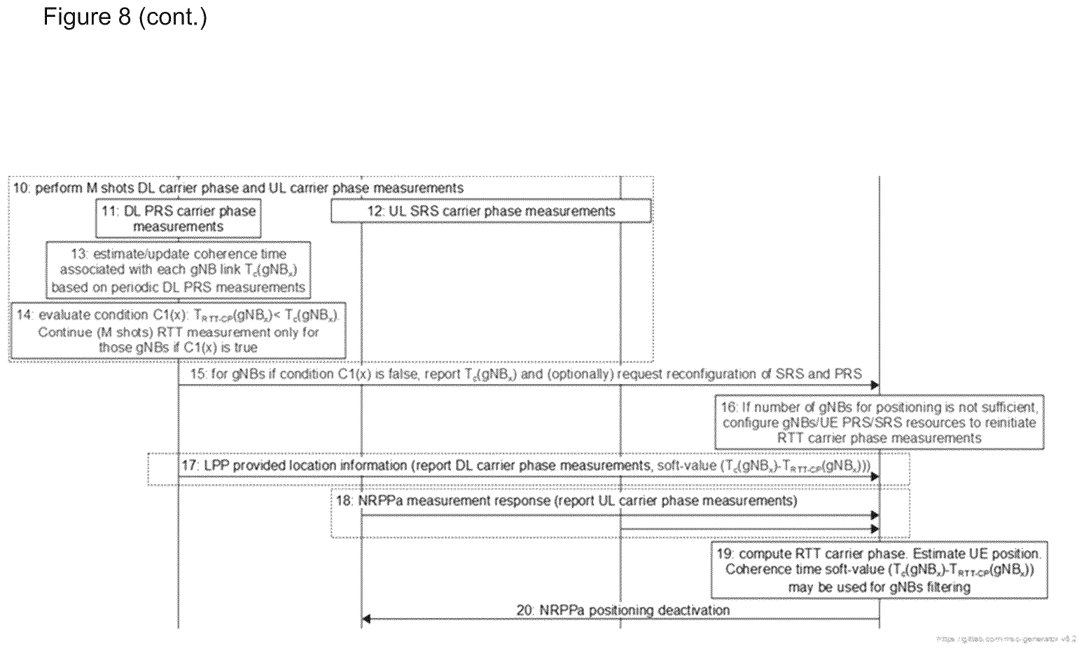

FIG. 7 shows a flowchart of a method according to an example embodiment. The method may be performed at a network function, e.g., a location management function (LMF).

In 701, the method comprises receiving by a network function, from a user equipment or a transmit receive point, at least one of the following: at least one reference signal carrier phase measurement or an indication of a determined coherence time.

A method as described with reference to FIG. 7 may comprise determining a required time period to perform M DL RSCP measurements with respect to a TRP based on a provided configuration on downlink positioning reference signals, DL PRS or to perform M UL RSCP measurements with respect to a UE based on uplink sounding reference signals, UL SRS and means for providing the determined time period to the network function. A TRP may perform UL RSCP measurement for an UL SRS resource using the same antenna used for a DL PRS transmission. The TRP may be able to perform the RSCP measurement for the UL SRS resource and the DL PRS transmission within coherence time.

Determining to provide at least one of the following: the at least one RSCP measurement or the determined coherence time to the network function may be further based on the determined time period. If the determined coherence time is greater than the determined time period, the method may comprise providing the at least one RSCP measurement to the network function and if the determined coherence time is less than the determined time period, the method may comprise providing an indication of the determined coherence time to the network function.

The apparatus may receive a request from the network function to provide the determined coherence time.

In one example embodiment, a UE decides to proceed with RTT carrier phase measurements, only with gNBs satisfying coherence time condition.

For example, the UE may report the DL RSCP measurement, but it also informs that the measurement is invalid for RTT-type Carrier Phase Positioning (CPP).

Alternatively, or in addition, the UE may perform DL RSCP measurements for all gNBs but the UE may report a part of the obtained DL RSCP measurements satisfying the coherence condition(s).

Alternatively, or in addition, a UE may decide to proceed with RTT carrier phase measurements with all gNBs. UE provides information to the network (LMF) to take further action to satisfy coherence time condition.

A network function (e.g., LMF) may configure UE to act according to one of the example embodiments described above. Alternatively, or in addition, the network LMF may the example embodiments to the UE, but the UE determines which one to use.

The trade off between different example embodiments is additional signalling or the payload-overhead from UE to LMF.

A method as described with reference to FIG. 7 may comprise receiving, from the network function, a coherence time determined at the network function for at least for one TRP.

The method may comprise receiving, from the network function, a request to perform M RSCP measurements based on the provided coherence time at least for one TRP and the determined coherence time of the apparatus, where M is an integer greater than or equal to 1.

Alternatively, or in addition, a method may comprise determining a required time period to perform M DL RSCP measurements with respect to a TRP based on a provided configuration on downlink positioning reference signals, DL PRS or to perform M UL RSCP measurements with respect to a UE based on a provided configuration on uplink sounding reference signals, UL SRS and providing the determined time period to the network function. The method may comprise determining whether the apparatus can perform the M RSCP measurements within the provided coherence time or the determined coherence time of the apparatus. M corresponds to the number of measurement samples. For latency reduction, M may be equal to 1, but an example typical value of M is 4. If the UE is able to multiple measurement samples within a coherence time condition, the measurement accuracy may be improved.

The network function may request a UE or TRP to provide the indication whether the RTT-type CP measurement can be evaluated for each DL PRS and UL SRS measurements (i.e. LMF request for the required time period).

The apparatus may transmit a request for reconfiguration at least one of the UL SRS or DL PRS to perform the M RSCP measurements within the provided coherence time or the determined coherence time of the apparatus. For example, one RSCP measurement may be a single RSCP measurement sample. The UE may perform RSCP measurements at a measurement instance where a single measurement instance is composed of the required time duration to receive multiple symbols of a single DL PRS resource. If the DL PRS resource is repeated, the same DL PRS resource is transmitted across multiple slots. In this case a single measurement instance would be multiple slots. In one embodiment, the UE may obtain multiple RSCP measurement samples from the repetition of the PRS resource. If the PRS resource is repeated M times across M slots, the UE may be able to obtain M RSCP measurements in a single measurement instance.

The network function may determine, based on the received coherence time, if a transmit receive point or user equipment is suitable for performing a positioning procedure. If there are insufficient user equipment or transmit receive points for performing the positioning procedure, the method may comprise providing a reconfiguration of reference signal resources to the user equipment or the transmit receive point.

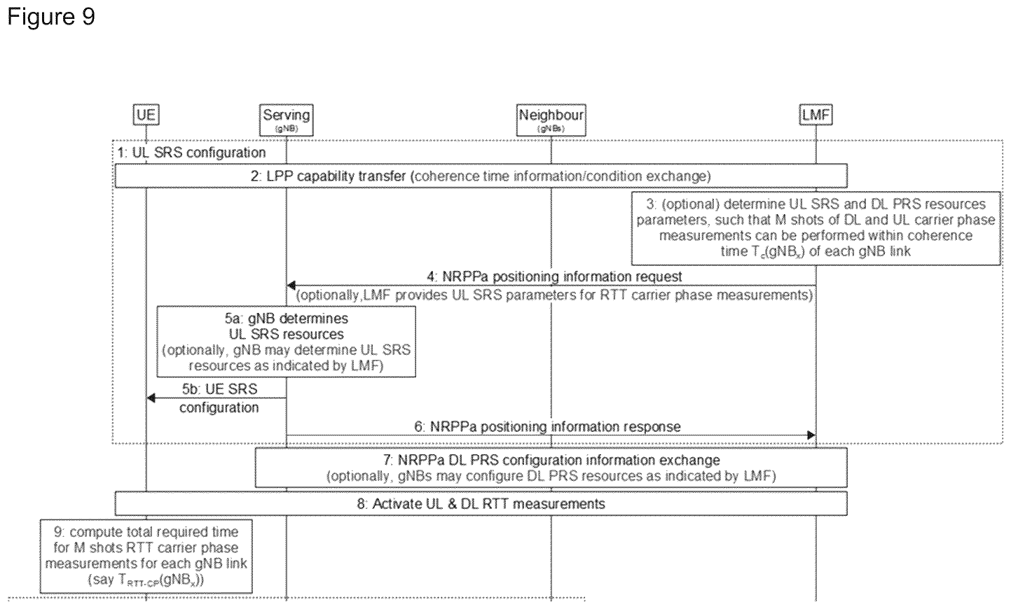

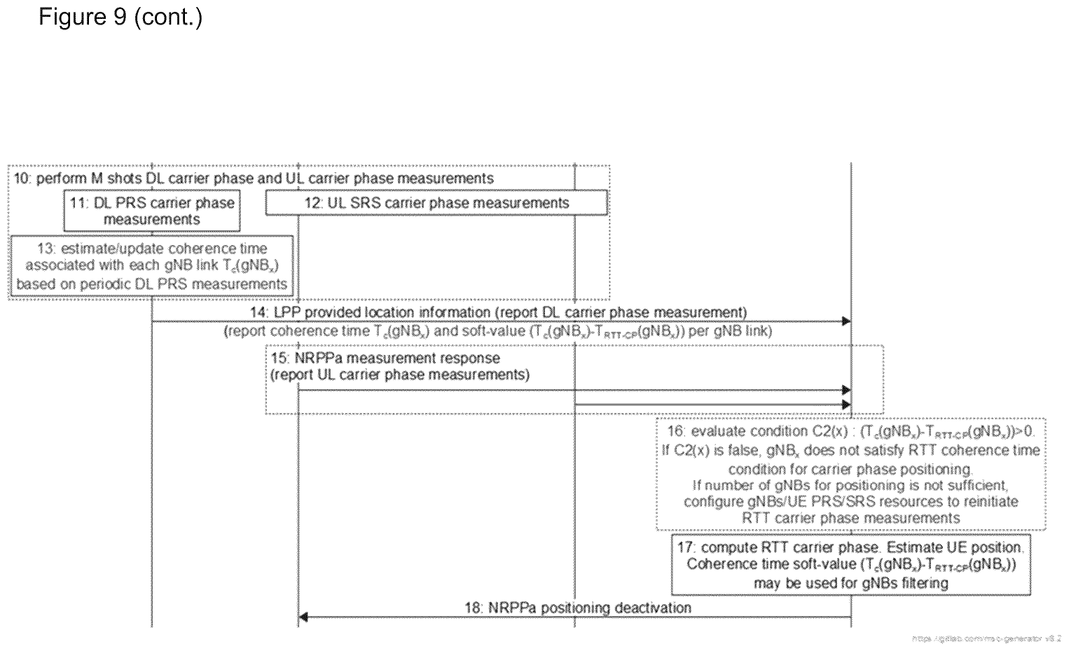

FIG. 9 shows an example signalling diagram for a method according to an example embodiment where a UE decides to proceed with RTT carrier phase measurements, only with gNBs satisfying coherence time condition (or LMF may request the UE to proceed with RTT carrier phase measurement (RSCP measurement) satisfying the coherence time condition). This is an example of determining to provide the at least one RSCP measurement based on the determined coherence time.

In step 1, gNBs and UE are configured for bi-directional carrier phase positioning.

In step 2, the LMF provides the UE with the coherence time conditions for each gNB or TRP. This is an example of receiving, from the network function, a coherence time determined at the network function on at least for one transmission and reception point, TRP. If the LMF is provided with the RF feature (e.g., coherence time of the phase supported by the specific RF chain/antenna of the gNB) from the gNBs and the LMF requests the UE to report the determined coherence time conditions for each gNB/TRP based on the information on UE RF (without consideration of gNB side as the UE may not be provided with it). The LMF determines the coherence time conditions considering both the UE and the gNB, and provide the UE with this information (i.e., the provided coherence time) so that the UE can determine coherence time conditions. The coherence time value of each gNB link T_{c}(gNBₓ) may be available to LMF due to prior reporting/statistical knowledge etc. For example, the LMF may determine the coherence time condition between the UE and each TRP based on the minimum value of the coherence time of the UE and the coherence time of TRP.

In one example embodiment, in step 2, the LMF requests the UE to report the determined coherence time conditions for each gNB/TRP based on the information on UE RF with consideration of (phase) coherency time of the gNB side. This is an example of receiving a request from the network function to provide the determined coherence time.

In an optional step 3, the LMF determines UL SRS and DL PRS resources parameters, such that M times RSCP measurement for the same DL PRS resource and/or UL SRS resource carrier phase measurements can be performed within coherence time of each gNB link (the value of M is set by LMF and is an integer greater than or equal to 1 and means a single measurement sample). For example, in FIG. 5, t3−t0 should be within the coherence time. This is an example of receiving, from the network function, a request to perform M RSCP measurements based on the provided coherence time at least for one TRP and the determined coherence time of the apparatus, where M is an integer greater than or equal to 1.

In step 4, the LMF indicates UL SRS parameters to a serving gNB to be configured to the UE (in step 5b) for the RTT carrier phase measurement.

In step 7, the LMF provides DL PRS parameter to gNBs to be configured for the RTT carrier phase measurement.

In step 9, the UE determines the total required time for M shots RTT carrier phase measurements (RSCP measurement) for each gNB link (see T_{RTT-CP}(gNBₓ) in FIG. 5. To do this, UE may use UL SRS and DL PRS scheduled information. This is an example of determining a required time period to perform M DL RSCP measurements with respect to a TRP based on a provided configuration on downlink positioning reference signals, DL PRS, and providing the determined time period to the network function.

In step 10, the UE performs M times RSCP measurements for the same DL PRS resource and/or UL SRS resource. This is an example of performing at least one reference signal carrier phase, RSCP, measurement.

In step 13, the UE estimates/updates coherence time associated with each gNB link T_{c}(gNBₓ) based on periodic DL PRS reception. This is an example of determining a coherence time, wherein coherence time is a time duration is a time duration that an initial phase of the signal does not change beyond a threshold.

In step 14, the UE evaluates condition C1(x): T_{RTT-CP}(gNBₓ)<T_{c}(gNBₓ) for each gNBₓ.

If C1(x) is true, the UE continues M shots RTT carrier phase measurements with those gNB for which condition C1(x) is true. This is an example of, providing the at least one RSCP measurement to the network function if the determined coherence time is greater than the determined time period.

In step 15, if C1(x) is false, the UE indicates to LMF that gNBₓ coherence time condition for RTT carrier phase measurement does not satisfy the condition. UE indicates to reconfigure PRS/SRS associated with gNBₓ satisfying condition C1(x). UE also indicates value of coherence time T_{c}(gNBₓ) to LMF. This is an example of providing an indication of the determined coherence time to the network function if the determined coherence time is less than the determined time period.

In step 16, the LMF takes a reconfiguration decision, if there is not enough gNBs left for positioning. This step may enable LMF to start new RTT carrier phase measurement session in addition to the current one. With Step-15 and Step-16. a network can take pre-emptive action to void previous allocated SRS/PRS resources and start new positioning measurement session with updated SRS/PRS resources. This also indicates (or flag) LMF to combine measurement from different positioning measurement sessions to estimate the position of UE. This is an example of determining there are insufficient user equipment or transmit receive points for performing the positioning procedure and means for providing a reconfiguration of reference signal resources to the user equipment or the transmit receive point.

In steps 17 and 18, the UE and gNBs provide DL and UL carrier phase measurements to LMF.

In step 17, the UE may also provide soft value of condition C1 (x), i.e., value T_{c}(gNBₓ)−T_{RTT-CP}(gNBₓ). The soft value of C1(x) can be used by LMF for gNB filtering.

In step 19, the LMF computes RTT carrier phase and performs a positioning estimate.

FIG. 10 shows an example signaling diagram for an example embodiment where a UE decides to proceed with RTT carrier phase measurements (RSCP measurements) with all gNBs. UE provides information for the network (LMF) to take further action to satisfying coherence time condition.

Steps 1 to 8 of FIG. 10 are as in FIG. 9.

In step 9, the UE performs M RSCP measurements for the same DL PRS resource and/or UL SRS resource.

In step 13, the UE estimates/updates coherence time associated with each gNB link IT_{c}(gNBₓ) based on periodic DL PRS reception.

In steps 14 and 15, the UE and gNBs provide DL and UL carrier phase measurements to LMF. This is an example of providing at least one RSCP measurement to a network function.

In step 14, the UE provide coherence time T_{c}(gNBₓ) value and soft value T_{c}(gNBₓ)−T_{RTT-CP}(gNBₓ) to LMF. This is an example of providing an indication determined coherence time.

In step 16, the LMF evaluates condition C2(x): T_{c}(gNBₓ)−T_{RTT-CP}(gNBₓ)>0 for each gNBₓ. If condition C2(x) is false, gNBₓ link does not satisfy RTT coherence time condition and is excluded for the positioning procedure.

If there is not enough gNBs for the positioning, LMF trigger to reconfigure PRS/SRS associated with gNBₓ satisfying condition C2(x), and re-initiate RTT carrier phase measurements.

In step 17, the LMF computes RTT carrier phase and perform positioning estimate.

An apparatus may comprise means for means for performing at least one reference signal carrier phase, RSCP, measurement for a signal, means for determining a coherence time, wherein coherence time is a time duration that an initial phase of the signal does not change beyond a threshold, means for determining, based on the determined coherence time, to provide at least one of the following to the network function: the at least one RSCP measurement or an indication of the determined coherence time and means for providing to a network function the determined at least one of the following: the at least one RSCP measurement or an indication of the determined coherence time.

The apparatus may comprise a user equipment, such as a mobile phone, or a TRP such as a gNB, be the user equipment or gNB or be comprised in the user equipment or gNB or a chipset for performing at least some actions of/for the user equipment or gNB.

Alternatively, or in addition, an apparatus may comprise means for receiving by a network function, from a user equipment or a transmit receive point, at least one of the following: at least one reference signal carrier phase measurement or an indication of a determined coherence time.

The apparatus may comprise a network function, such as a LMF, be the network function or be comprised in the network function or a chipset for performing at least some actions of/for the network function.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems such as 6G networks or 5G-Advanced networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
I hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media. The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1.-23. (canceled)

24. An apparatus comprising:
means for performing at least one reference signal carrier phase, RSCP, measurement for a signal;
means for determining a coherence time, wherein coherence time is a time duration that an initial phase of the signal does not change beyond a threshold;
means for determining, based on the determined coherence time, to provide at least one of the following to the network function: the at least one RSCP measurement or an indication of the determined coherence time; and
means for providing to a network function the determined at least one of the following: the at least one RSCP measurement or an indication of the determined coherence time.

25. The apparatus according to claim 24, further comprising means for receiving, from the network function, a coherence time determined at the network function at least for one transmission and reception point, TRP.

26. The apparatus according to claim 25, further comprising means for receiving, from the network function, a request to perform M RSCP measurements based on the provided coherence time at least for one TRP and the determined coherence time of the apparatus, where M is an integer greater than or equal to 1.

27. The apparatus according to claim 24, further comprising means for determining a required time period to perform M DL RSCP measurements with respect to a TRP based on a provided configuration on downlink positioning reference signals, DL PRS or to perform M UL RSCP measurements with respect to a UE based on a provided configuration in uplink sounding reference signals, UL SRS and means for providing the determined time period to the network function.

28. The apparatus according to claim 27, further comprising means for determining whether the apparatus can perform the M RSCP measurements within the provided coherence time or the determined coherence time.

29. The apparatus according to claim 28, further comprising means for transmitting a request for reconfiguration of at least one of the UL SRS or DL PRS to perform the M RSCP measurements within the provided coherence time or the determined coherence time.

30. The apparatus according to claim 27, wherein means for determining to provide at least one of the following: the at least one RSCP measurement or the determined coherence time to the network function is further based on the determined time period.

31. The apparatus according to claim 30, wherein if the determined coherence time is greater than the determined time period, the apparatus comprises means for providing the at least one RSCP measurement to the network function and if the determined coherence time is less than the determined time period, the apparatus comprises means for providing an indication of the determined coherence time to the network function.

32. The apparatus according to claim 24, further comprising means for receiving a request from the network function to provide the determined coherence time.

33. The apparatus according to claim 24, wherein the network function comprises a location management function, the apparatus comprises a transmit receive point and the RSCP measurements are based on an uplink sounding reference signal or the apparatus comprises a user equipment and the RSCP measurements are based on a downlink positioning reference signal transmission.

34. An apparatus comprising:
means for receiving by a network function, from a user equipment or a transmit receive point, at least one of the following: at least one reference signal carrier phase measurement or an indication of a determined coherence time.

35. The apparatus according to claim 34, further comprising means for providing, from the network function, a coherence time determined at the network function for at least for one transmission and reception point, TRP.

36. An apparatus according to claim 35, further comprising means for providing, from the network function, a request to perform M RSCP measurements based on the provided coherence time at least for one TRP and a determined coherence time of the apparatus, where M is an integer greater than or equal to 1.

37. The apparatus according to claim 34, further comprising means for providing a configuration on downlink positioning reference signals, DL PRS, and means for receiving a determined required time period to perform M RSCP measurements with respect to a TRP based on the received configuration or means for providing a configuration on uplink sounding reference signals, UL SRS, and means for receiving a determined required time period to perform M RSCP measurements with respect to a UE based on the provided configuration.

38. The apparatus according to claim 34, further comprising means for providing a request from the network function to the transmit receive point or the user equipment to provide the determined coherence time.

39. The apparatus according to claim 34, further comprising means for determining, based on the received coherence time, if a transmit receive point or user equipment is suitable for performing a positioning procedure.

40. The apparatus according to claim 39, further comprising means for determining there are insufficient user equipment or transmit receive points for performing the positioning procedure and means for providing a reconfiguration of reference signal resources to the user equipment or the transmit receive point.

41. An apparatus comprising:
at least one processor, and at least one memory storing instructions which, when executed by the processor, cause the apparatus at least to:
perform at least one reference signal carrier phase, RSCP, measurement for a signal;
determine a coherence time, wherein coherence time is a time duration that an initial phase of the signal does not change beyond a threshold;
determine, based on the determined coherence time, to provide at least one of the following to the network function: the at least one RSCP measurement or an indication of the determined coherence time; and
provide to a network function the determined at least one of the following: the at least one RSCP measurement or an indication of the determined coherence time.
